(19) United States
(12) Patent Application Publication
(10) Pub. No.: US 2012/0151731 A1
(43) Pub. Date: Jun. 21, 2012

(54) Apparatus and Method for Manufacturing a Beam Section

(75) Inventor: Douglas Allen Zoller, Bay Village, OH (US)

(73) Assignee: The American Tank & Fabricating Company, Cleveland, OH (US)

(21) Appl. No.: 13/325,226

(22) Filed: Dec. 14, 2011

Related U.S. Application Data
(60) Provisional application No. 61/423,366, filed on Dec. 15, 2010.

(51) Int. Cl. B23Q 17/00; B23Q 15/00

(52) U.S. Cl. 29/407.05; 29/705

(57) ABSTRACT

Provided is a beam component fixturing apparatus comprising a locator surface set for a first dimension, a locator surface set for a second dimension, and a locator surface set for a third dimension. The locator surface set for a first dimension may comprise a first locator surface for the first dimension and a second locator surface for the first dimension adapted to provide a compressive load on a beam component placed therebetween. The locator surface set for a second dimension may comprise a first locator surface for the second dimension and a second locator surface for the second dimension adapted to provide a compressive load on a beam component placed therebetween. The locator surface set for a third dimension may comprise a first locator surface for the third dimension and a second locator surface for the third dimension adapted to provide a compressive load on a beam component placed therebetween.

### TECHNICAL FIELD

Certain embodiments disclosed herein relate generally to fabrication of structural beams. More specifically, certain embodiment disclosed herein related generally to securing together the components of structural beams.

### BACKGROUND

Structural beams come in a wide variety of forms. The form of a structural beam may be determined by a set of variables that may comprise the geometry of the beam and the material of the beam.

One method of fabrication of structural beams comprises welding together two or more components of structural beams. In some embodiments, the components of the structural beam may comprise a web and a flange. In some embodiments, the web and the flange may be joined together by a joining operation to form a beam.

Many materials undergo dimensional change in response to temperature change. Dimensional change in response to temperature change may also be known as thermal strain. Without limitation, some materials expand when heated and contract when cooled.

A joining operation may comprise heating of one or more components to be joined. In some joining processes, the component may have its temperatures changed dramatically from the temperature to which the component will be subjected to during normal use. In some joining processes one component or one part of the component may be heated or have its temperature changed unevenly with respect to other parts of the same component or other components. Uneven heating can result in uneven thermal strain or thermal distortion.

In some operations, uneven thermal strain of a component may result in unacceptable product quality, or may result in additional undesirable manufacturing cost or time. In some joining operations thermal strain of a component during or after joining operations may not be negligible and may result in unacceptable product quality, or may result in additional undesirable manufacturing cost or time. In some operations, uneven thermal strain or thermal distortion may result in unacceptable bending or warpage of the finished beam.

It remains desirable to provide methods of securing the components of beams so that uneven strain or distortion of the beam during or after joining operations, does not result in unacceptable product quality and does not result undesirable additional manufacturing cost or time.

### SUMMARY

Provided is a beam component fixturing apparatus comprising a locator surface set for a first dimension, a locator surface set for a second dimension, and a locator surface set for a third dimension. The locator surface set for a first dimension may comprise a first locator surface for the first dimension and a second locator surface for the first dimension adapted to provide a compressive load on a beam component placed therebetween. The locator surface set for a second dimension may comprise a first locator surface for the second dimension and a second locator surface for the second dimension adapted to provide a compressive load on a beam component placed therebetween. The locator surface set for a third dimension may comprise a first locator surface for the third dimension and a second locator surface for the third dimension adapted to provide a compressive load on a beam component placed therebetween.

Further provided is a beam component fixturing apparatus, comprising a first locator surface set for a first dimension, a first locator surface set for a second dimension, a first locator surface set for a third dimension, a second locator surface set for the third dimension, and a third locator surface set for the third dimension. The second dimension may be perpendicular to the first dimension and the third dimension may be parallel to the second dimension. The first locator surface set for the first dimension may comprise, a first locator surface for the first dimension engaged with an actuator, a substantially fixed second locator surface for the first dimension, and the first locator surface for the first dimension and said second locator surface for the first dimension may be adapted to provide a compressive load on a beam component placed therebetween. The first locator surface set for the second dimension may comprise, a first locator surface for the second dimension engaged with an actuator, a substantially fixed second locator surface for the second dimension, and the first locator surface for the second dimension and said second locator surface for the second dimension may be adapted to provide a compressive load on a beam component placed therebetween. The first locator surface set for the third dimension may comprise, a first locator surface for the third dimension engaged with an actuator, a substantially fixed second locator surface for the third dimension, and the first locator surface for the third dimension and the second locator surface for the third dimension may be adapted to provide a compressive load on a beam component placed therebetween. The second locator surface set for the third dimension may comprise, a third locator surface for the third dimension engaged with an actuator, a substantially fixed fourth locator surface for the third dimension, and the third locator surface for the third dimension and the fourth locator surface for the third dimension may be adapted to provide a compressive load on a beam component placed therebetween. The third locator surface set for the third dimension may comprise, a fifth locator surface for the third dimension engaged with an actuator, a substantially fixed sixth locator surface for the third dimension, and the fifth locator surface for the third dimension and the sixth locator surface for the third dimension may be adapted to provide a compressive load on a beam component placed therebetween. At least one locator surface may comprise a rollable surface.

Further provided is a method of fixturing a beam component. A method of fixturing a beam component may comprise clamping a first beam component within a first locator surface set for a first dimension, clamping a second beam component within a first locator surface set for a second dimension, and clamping the first beam component within a first locator surface set for a third dimension. The first locator surface set for the first dimension may comprise a first locator surface for the first dimension and a second locator surface for the first dimension. The first locator surface set for the second dimension may comprise a first locator surface for the second dimension, and a second locator surface for the second dimension. The first locator surface set for the third dimension may comprise a first locator surface for the third dimension, and a second locator surface for the third dimension.

### BRIEF DESCRIPTION OF THE DRAWINGS

FIG. 1 is a cross-sectional view of a beam;

FIG. 2 is a view of one embodiment of a fixture;

FIG. 3 is a close up view of one embodiment of a fixture;

FIG. 4 is another view of one embodiment of a fixture;

FIG. 5 is a view of one embodiment of a fixture;

FIG. 6 is a view of a side component of one embodiment of a fixture;

FIG. 7 is a view of a top component of one embodiment of a fixture; and

FIG. 8 is a view of an associated conveyer roller system with one embodiment of a beam thereupon.

### DETAILED DESCRIPTION

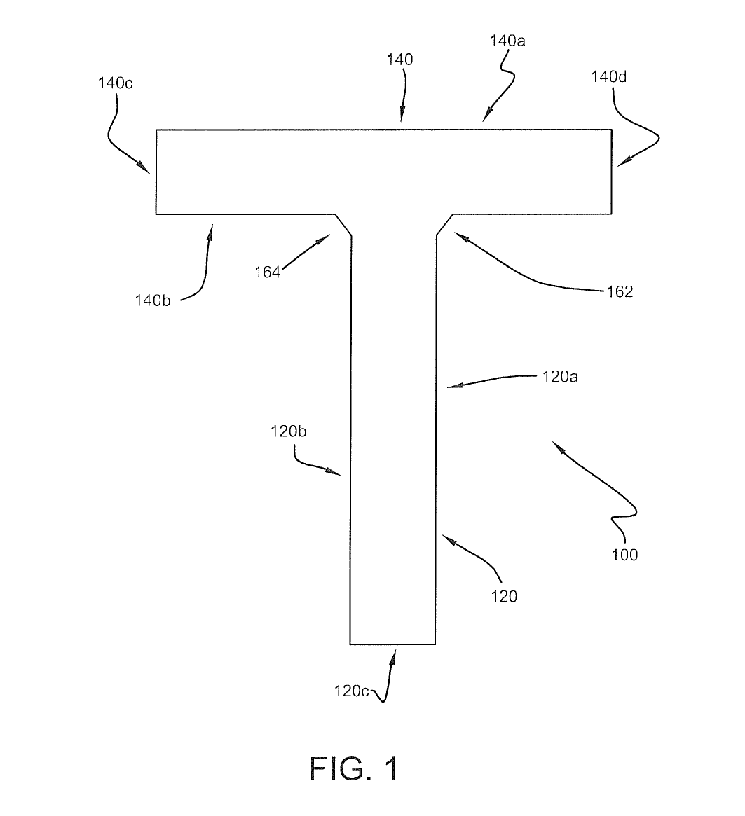

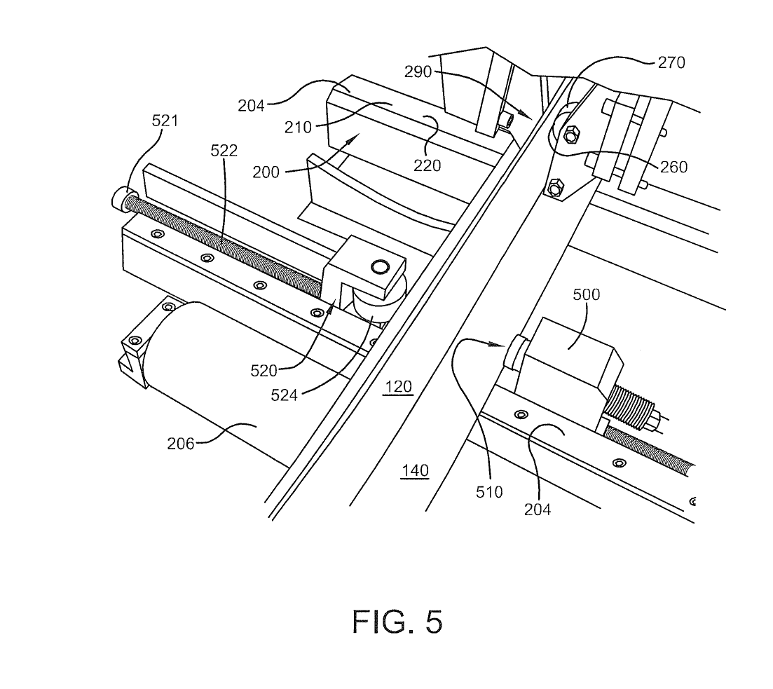

Reference will be made to the drawings, FIGS. 1-8, wherein the showings are only for purposes of illustrating certain embodiments of an apparatus and method for manufacturing a beam section, and not for purposes of limiting the same.

As noted above, the form of a structural beam depends, at least in part, on the geometry of the beam and the material of the beam. In some embodiments, a beam may be comprised of multiple beam components joined to form the beam. A beam component may comprise a web or a flange.

Structural beams may comprise I-beams, T-beams, angles, channels, hollow structural sections, and other geometries. The geometry of a beam may also be defined by parameters that may comprise, the length of the beam, the height of the beam, the weight of the beam per unit length, flange width, web thickness, flange thickness, cross-sectional area, and cross-sectional moment of inertia.

Structural beams come in a wide variety of materials. Structural beams may comprise structural materials. Structural materials may comprise steel, stainless steel, iron, iron alloys, aluminum, aluminum alloys, titanium, titanium alloys, nickel, nickel alloys, other metals or metal alloys, composite materials, polymers, wood, concrete, and other materials. Steel may comprise, carbon steels, high strength low alloy steels, corrosion resistant high strength low alloy steels, and quenched and tempered alloy steels.

A structural beam may be formed from multiple beam components. A beam component may be in the form of a plate, a strap, a rod, or another form. In some embodiments, the beam components may comprise a first beam component and a second beam component, where the first beam component comprises a web and the second beam component comprises a flange. In some embodiments the beam components may be elongated beam components. In some embodiments, the beam components may comprise a first beam component and a second beam component, where the first beam component may comprise an elongated web and the second beam component may comprise an elongated flange. A beam component of a beam may comprise any of the above listed structural materials.

Without limitation, FIG. 1 shows a cross-section of a T-beam 100. T-beam 100 may comprise a web 120 and a flange 140. Because the view is of a cross-section, the T-beam 100 shown in FIG. 1 has an axis of elongation that is perpendicular to the cross-sectional plane. Stated another way, the T-beam shown in FIG. 1 has an axis of elongation that extends into or out of the page plane. The web 120 and the flange 140 may be elongated components and may have axes of elongation that are perpendicular to the cross-sectional plane. Without limitation, in some embodiments, the axes of elongation of the components of the beam 100 may be all parallel to the axis of elongation of the beam 100. The elongated web 120 and the elongated flange 140 may be joined together to form beam 100 by weld 162 and weld 164.

The beam components 120, 140 may be joined to form the structural beam 100. In certain embodiments, such as, without limitation, that shown in FIG. 1, beam 100 may be formed from a plurality of elongated straps of material, with first beam component 120 forming a web joined to second beam component 140 forming a flange. A process that may be used to join the components of structural beam 100 is a joining process. A joining process may depend upon the material or materials from which the beam components 120, 140 are formed. A joining process that may be appropriate to join the components of structural beam 100 may comprise welding, brazing, soldering, use of adhesives, use of mechanical fasteners, or some combination thereof. For example, and without limitation, steel beam components 120, 140 may be joined by welding to form a steel beam 100.

In certain embodiments, and without limitation, a plurality of beam components 120, 140 may be held substantially fixed with respect to one another during a process used to join the beam components 120, 140 into the structural beam 100. In certain embodiments and without limitation, sections of beam components 120, 140 may be held substantially fixed with respect to one another during the process used to join the beam components 120, 140 into the structural beam 100.

In certain embodiments, and without limitation, a beam component 140 may comprise a first surface 140a, a second surface 140b substantially opposite the first surface 140a, a third surface 140c extending between the first surface 140a and the second surface 140b, and a fourth surface 140d substantially opposite the third surface 140c. In certain embodiments, and without limitation, a beam component 120 may comprise a first surface 120a, a second surface 120b substantially opposite the first surface 120a, a third surface 120c extending between the first surface 120a and the second surface 120b, and a fourth surface (not shown) substantially opposite the third surface 140c.

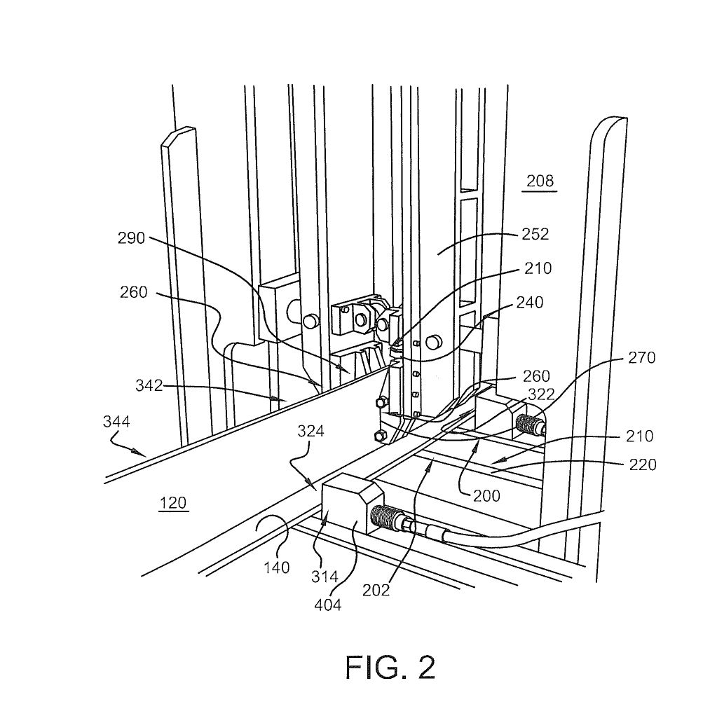

As shown in FIGS. 2-8 and without limitation, a fixture 200 may hold or secure a section of a beam component 120, 140 substantially fixed in one or more dimensions. In certain embodiments, and without limitation, a section of first beam component 120 may be held substantially fixed with respect to a section of second beam component 140 in one or more dimensions by the fixture 200. In certain embodiments, some portions of the fixture 200 may be free to move with respect to other portions of the fixture 200. In certain embodiments and without limitation, a first section of first beam component 120 may be held substantially fixed with respect to a first section of second beam component 140 in one or more dimensions by a fixture 200, wherein the fixture 200 may permit a second section of first beam component 120 to move with respect to a second section of second beam component 140 or may permit a section of first beam component 120 or a section of second beam component 140 to move with respect to the ground, or to move with respect to certain portions of the fixture 200. In certain embodiments and without limitation, a section of first beam component 120 may be held substantially fixed with respect to a section of second beam component 140 in one or more dimensions by a fixture 200, by exerting a compressive force on the section of first beam component 120 and on the section of second beam component 140.

In certain embodiments, and without limitation, a fixture 200 may comprise a locator surface set for dimension one 210, a locator surface set for dimension two 260, and a locator surface set for dimension three 310. In certain embodiments, and without limitation, a fixture 200 may comprise one or more of a locator surface set for dimension one 210, a locator surface set for dimension two 260, a first locator surface set for dimension three 310, a second locator surface set for dimension three 312, and a third locator surface set for dimension three 314.

In certain embodiments, and without limitation, a locator surface set for dimension one 210 may comprise a first locator surface for dimension one 220 and a second locator surface for dimension one 240. In certain embodiments, the first locator surface for dimension one 220 may be movable in a first dimension, dimension one. In certain embodiments, the second locator surface for dimension one 240 may be movable in the first dimension. In certain embodiments, and without limitation as shown in FIGS. 2-4, the first locator surface for dimension one 220 may be fixed from moving. In certain embodiments, and without limitation as shown in FIGS. 2-4, the first locator surface for dimension one 220 may be fixed from moving and the second locator surface for dimension one 240 may be movable in the first dimension. In certain embodiments, and without limitation, as shown in FIGS. 2-4, the first locator surface for dimension one 220 and the second locator surface for dimension one 240 may be adapted to provide a compressive load on a material, object, or beam component 120, 140 placed therebetween. In certain embodiments, and without limitation, as shown in FIGS. 2-4, the first locator surface for dimension one 220 the second locator surface for dimension one 240 may be adapted to provide a compressive load on beam components 120, 140 placed therebetween. In certain embodiments a compressive load on beam components 120, 140 may force the beam components 120, 140 together and into direct engagement with one another, or may hold one or more beam components fixed with respect to fixture 200, or both.

In certain embodiments, and without limitation, a locator surface set for dimension two 260 may comprise a first locator surface for dimension two 270 and a second locator surface for dimension two 290. In certain embodiments, the first locator surface for dimension two 270 may be movable in a second dimension, dimension two. In certain embodiments, the second locator surface for dimension two 290 may be movable in the second dimension. In certain embodiments and without limitation, dimension two may be at an angle to dimension one. In certain embodiments and without limitation, dimension two may be perpendicular to dimension one. In certain embodiments, and without limitation as shown in FIGS. 2-4, the second locator surface for dimension two 290 may be fixed from moving. In certain embodiments, and without limitation as shown in FIGS. 2-4, the second locator surface for dimension two 290 may be fixed from moving and the first locator surface for dimension two 270 may be movable in the second dimension. In certain embodiments, and without limitation, as shown in FIGS. 2-4, the first locator surface for dimension two 270 and the second locator surface for dimension two 290 may be adapted to provide a compressive load on a material, object, or beam component 120, 140 placed therebetween. In certain embodiments a compressive load on beam components 120, 140 may hold one or more beam components fixed with respect to fixture 200.

In certain embodiments, and without limitation, a first locator surface set for dimension three 310 may comprise a first locator surface for dimension three 320 and a second locator surface for dimension three 340. In certain embodiments, the first locator surface for dimension three 320 may be movable in a third dimension, dimension three. In certain embodiments, the second locator surface for dimension three 340 may be movable in the third dimension. In certain embodiments, and without limitation as shown in FIGS. 2-4, the second locator surface for dimension three 340 may be fixed from moving. In certain embodiments, and without limitation as shown in FIGS. 2-4, the second locator surface for dimension three 340 may be fixed from moving and the first locator surface for dimension three 320 may be movable in the third dimension. In certain embodiments, and without limitation, as shown in FIGS. 2-4, the first locator surface for dimension three 320 and the second locator surface for dimension three 340 may be adapted to provide a compressive load on a material, object, or beam component 120, 140 placed therebetween. In certain embodiments a compressive load on beam components 120, 140 may hold one or more beam components fixed with respect to fixture 200.

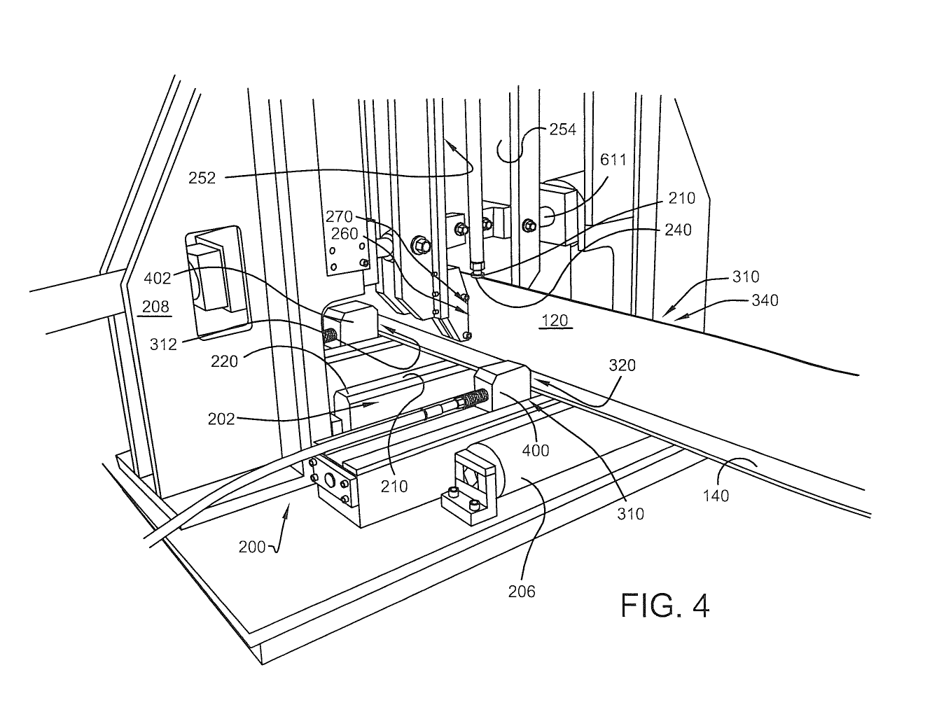

In certain embodiments, and without limitation, a second locator surface set for dimension three 312 may comprise a third locator surface for dimension three 322 and a fourth locator surface for dimension three 342. In certain embodiments, the third locator surface for dimension three 322 may be movable in a third dimension, dimension three. In certain embodiments, the fourth locator surface for dimension three 342 may be movable in the third dimension. In certain embodiments, and without limitation as shown in FIGS. 2 and 4, the fourth locator surface for dimension three 342 may be fixed from moving. In certain embodiments, and without limitation as shown in FIGS. 2 and 4, the fourth locator surface for dimension three 342 may be fixed from moving and the third locator surface for dimension three 322 may be movable in the third dimension. In certain embodiments, and without limitation, as shown in FIGS. 2 and 4, the third locator surface for dimension three 322 and the fourth locator surface for dimension three 342 may be adapted to provide a compressive load on a material, object, or beam component 120, 140 placed therebetween. In certain embodiments a compressive load on beam components 120, 140 may hold one or more beam components fixed with respect to fixture 200.

In certain embodiments, and without limitation, a third locator surface set for dimension three 314 may comprise a fifth locator surface for dimension three 324 and a sixth locator surface for dimension three 344. In certain embodiments, the fifth locator surface for dimension three 324 may be movable in a third dimension, dimension three. In certain embodiments, the sixth locator surface for dimension three 344 may be movable in the third dimension. In certain embodiments, and without limitation as shown in FIG. 2, the sixth locator surface for dimension three 344 may be fixed from moving. In certain embodiments, and without limitation as shown in FIG. 2, the sixth locator surface for dimension three 344 may be fixed from moving and the fifth locator surface for dimension three 324 may be movable in the third dimension. In certain embodiments, and without limitation, as shown in FIG. 2, the fifth locator surface for dimension three 324 and the sixth locator surface for dimension three 344 may be adapted to provide a compressive load on a material, object, or beam component 120, 140 placed therebetween. In certain embodiments a compressive load on beam components 120, 140 may hold one or more beam components fixed with respect to fixture 200.

In certain embodiments, and without limitation, the first locator surface for dimension one 220, or the second locator surface for dimension one 240, or the first locator surface for dimension two 270, or the second locator surface for dimension two 290, or the first locator surface for dimension three 320, or the second locator surface for dimension three 340, or some combination thereof, may be movable or adapted to provide a compressive load on a material, object, or beam component 120, 140.

Any locator surface 220, 240, 270, 290, 320, 340, 322, 342, 324, 344 that is movable or adapted to provide a compressive load on a material, object, or beam component 120, 140 may be engaged directly or indirectly with an actuator 400, 402, 404, 500, 520, 600, 610, 700. An actuator 400, 402, 404, 500, 520, 600, 610, 700 may be any component adapted to provide a load upon an element or component engaged therewith. A load may comprise a selectable force, moment, pressure, energy, work, or torque. An actuator 400, 402, 404, 500, 520, 600, 610, 700 may comprise hydraulic machinery 400, 402, 404, 500, 600, 610, 700 pneumatic machinery, a mechanism 520 or some combination thereof. Hydraulic machinery 400, 402, 404, 500, 600, 610, 700 may comprise a hydraulic cylinder 600, 610, 700, a hydraulic pump, a valve, a reservoir, an accumulator, hydraulic fluid, or some combination thereof. Pneumatic machinery may comprise a pneumatic cylinder, a compressor or other pressurized gas source, a valve, an reservoir, bottle, or other gas storage device, a gas, or some combination thereof. A mechanism 520 may comprise, an input link, an output link, an connector link, a linkage, a lever, a pivot, a fulcrum, an axle, a male threaded component 522, a female threaded component 521, a spring, or some combination thereof.

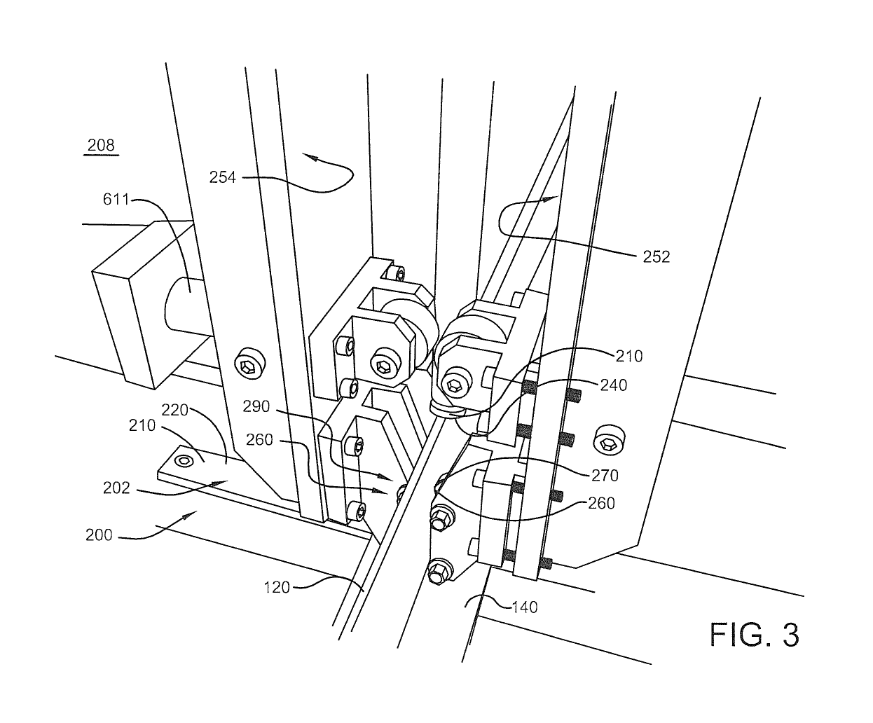

A locator surface 220, 240, 270, 290, 320, 340, 322, 342, 324, 344 may comprise either a rollable or non-rollable surface. A locator surface set 210, 260, 310, 312, 314 may engage objects located therebetween with a locator surface 220, 240, 270, 290, 320, 340, 322, 342, 324, 344. As noted above, and as shown in FIGS. 2-5, a locator surface 220, 240, 260, 270, 290, 320, 340, 322, 342, 324, 344 may comprise either a rollable or non-rollable surface. Without limitation, a non-rollable surface may comprise a fixed surface, such as a block or plate, that may provide resistance in the form of friction forces to movement parallel to the surface and resistance in the form of normal forces to movement into the surface. In some embodiments, a non-rollable locator surface 220, 240, 320, 322, 324, 510 may comprise a fixed surface that is substantially planar as shown in FIG. 3. In some embodiments, a non-rollable locator surface may comprise a fixed surface that may be curved or comprise grooves, teeth, flanges or other engagement geometries. In certain embodiments, and without limitation, a rollable surface 260, 270, 290, 524 may comprise a roller, bearing, or wheel, that provides resistance, in the form of normal forces to movement into the surface but permits movement by rolling in one or more dimensions, and may provide resistance the form of friction forces to movement parallel to the surface in one dimension. Without limitation and as shown in FIGS. 2-5, a rollable surface may roll to allow an object in contact therewith to move in a dimension perpendicular to the axis along which the clamping force may be applied.

The first dimension, dimension one, may be any spatial dimension. In certain embodiments, and without limitation, the first dimension may be horizontal.

The second dimension, dimension two, may be any spatial dimension. In certain embodiments, and without limitation, the second dimension may perpendicular to the first dimension. In certain embodiments, and without limitation, the second dimension may be selectable among a group of dimensions perpendicular to the first dimension. In certain embodiments, and without limitation, the second dimension may be vertical.

The third dimension, dimension three, may be any spatial dimension. In certain embodiments, and without limitation, the third dimension may be perpendicular to the second dimension. In certain embodiments, and without limitation, the third dimension may be parallel to the first dimension. In certain embodiments, and without limitation, the third dimension may be horizontal.

Referring now to FIGS. 2-5, without limitation, in one embodiment, a fixture 200 may comprise a work plane 202 defined by one or more ribs 204, plates, rollers 206, rods, or other surfaces. In certain embodiments, as shown in FIGS. 2-5, and without limitation, the work plane 202 may be substantially parallel to, or coincident with, or identical to the first locator surface for dimension one 220.

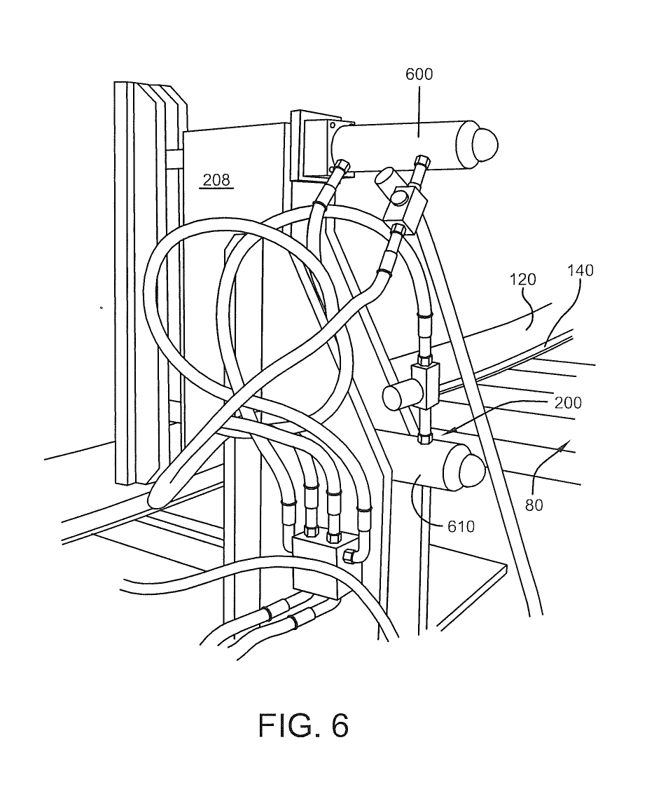

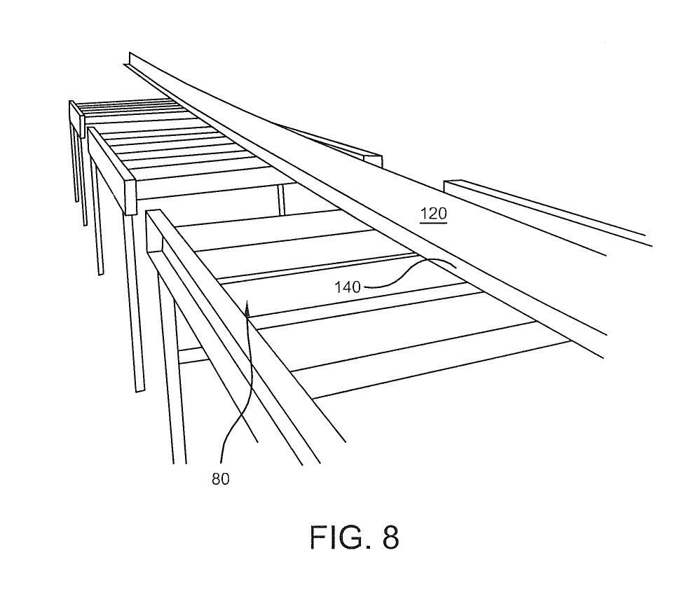

In certain embodiments, as shown in FIGS. 6 and 8, without limitation, the work plane 202 may be operably engaged with a conveyor or roller track or other material handling system 80 adapted to introduce a beam 100 or one or more beam components 120, 140 to the fixture 200 or to receive a beam 100 or one or more beam components 120, 140 from the fixture 200.

In certain embodiments, as shown in FIGS. 2, 3, 4, and 6, without limitation, the fixture 200 may comprise a frame element 208 fixedly engaged with respect to the fixture 200. A frame element 208 may provide a surface, platform, or purchase point to which other elements of the fixture may be engaged.

In certain embodiments, as shown in FIGS. 2, 3, 4, and 6, without limitation, a fixture 200 may comprise a first platen 252. The first platen 252 may define a plane comprising the first dimension, or a plane parallel to a plane comprising the first dimension. The first platen 252 may be movably engaged with respect to the frame element 208. In certain embodiments, as shown in FIG. 6 and without limitation, the first platen 252 may be engaged to the frame element 208 in a manner that permits the first platen to be rotated about a dimension parallel to the first dimension or translated along a dimension perpendicular to the first dimension. In certain embodiments, as shown in FIG. 6 and without limitation, the first platen 252 may be engaged to the frame element 208 in a manner that permits the first platen to be translated along the second dimension. In certain embodiments, as shown in FIG. 6 and without limitation, the first platen may be engaged to the frame element 208 by one or more actuators 600, 610 that may be separately controlled to allow for different actuation or adjustment. In certain embodiments, the first platen 252 may define a plane perpendicular to the work plane 202.

In certain embodiments, as shown in FIGS. 2-4, and 6 without limitation, a fixture 200 may comprise a second platen 254. The second platen 254 may define a plane substantially parallel to the plane defined by the first platen 252. The second platen 254 may be movably engaged with respect to the frame element 208. In certain embodiments, as shown in FIG. 6 and without limitation, the second platen 254 may be engaged to the frame element 208 in a manner that permits the second platen 254 to be rotated about a dimension parallel to the first dimension or translated along a dimension perpendicular to the first dimension. In certain embodiments, as shown in FIG. 6 and without limitation, the second platen 254 may be engaged to the frame element 208 in a manner that permits the second platen 254 to be translated along the second dimension. In certain embodiments, as shown in FIG. 6 and without limitation, the second platen 254 may be engaged to the frame element 208 by one or more adjustable elements 601, 611 that may be separately adjusted. In certain embodiments, the second platen 254 may define a plane perpendicular to the work plane 202.

In certain embodiments, as shown in FIG. 2, the first locator surface for dimension two 270 may be engaged with the first platen 252. In certain embodiments, as shown in FIG. 2, the second locator surface for dimension two 290 may be engaged with the second platen 254.

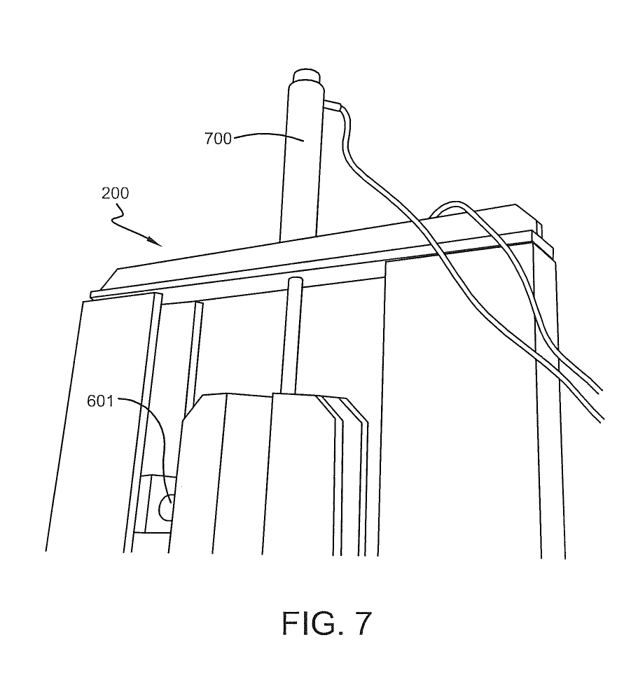

In certain embodiments, as shown in FIGS. 7, without limitation, the fixture 200 may comprise an actuator 700 engaged with the frame element 208 and operationally engaged with the second locator surface for dimension one 240, An actuator 700 may be operated to move the second locator surface for dimension one 240 along the first dimension either nearer to, or further from the first locator surface for dimension one 220.

In certain embodiments, as shown in FIGS. 4, without limitation, the fixture 200 may comprise an actuator 400 operationally engaged with work plane 202 and the first locator surface for dimension three 320. Similarly the second locator surface for dimension three 340 may be adjustably engaged with work plane 202. An actuator 400 may be operated to move the first locator surface for dimension three 320 along the third dimension either nearer to, or further from the second locator surface for dimension three 340.

A fixture 200 may be used in a process for forming a beam 100. Without limitation, a fixture 200 may be used in a process for forming a beam 100 by holding particular sections of beam components 120, 140 in a desired position and orientation with respect to one another while a joining operation, such as welding, is performed to engage the sections to one another.

As shown in FIGS. 2, 4, and 5, and without limitation, a beam component 140 may be introduced into a fixture 200. As noted above, in certain embodiments, a beam component 140 may comprise a first surface 140a, a second surface 140b substantially opposite the first surface 140a, a third surface 140c extending between the first surface 140a and the second surface 140b, and a fourth surface 140d substantially opposite the third surface 140c. In certain embodiments, and without limitation, a beam component 140 introduced into a fixture 200 may have its first surface 140a located upon the first locator surface for dimension one 220. As noted above, in some embodiments the first locator surface for dimension one 220 is work plane 202. As shown in FIGS. 2-5, and without limitation, a beam component 120 may be introduced into a fixture 200. As noted above, in certain embodiments, a beam component 120 may comprise a first surface 120a, a second surface 120b substantially opposite the first surface 120a, a third surface 120c extending between the first surface 120a and the second surface 120b, and a fourth surface (not shown) substantially opposite the third surface 140c. In certain embodiments, and without limitation, a beam component 120 introduced into a fixture 200 may have its fourth surface 120d located upon the second surface 140b of beam component 140. As shown in FIGS. 2-4, in certain embodiments, and without limitation, a beam component introduced into a fixture 200 may have its third surface 120c located by the second locator surface for dimension one 240. In certain embodiments, and without limitation, the second locator surface for dimension one 240 may be engaged with an actuator 700 adapted to apply a load to third surface 120c and thereby compress fourth surface 120d against the second surface 140b of beam component 140 and thereby hold the section of beam component 120 and the second of beam component 140 coinciding with locator surface set for dimension one 210 together and in a location along dimension one defined by the above-noted first locator surface for dimension one 220.

As shown in FIG. 4, in certain embodiments, and without limitation, a beam component introduced into a fixture 200 may have its fourth surface 140d located upon the second locator surface for dimension three 340. The beam component introduced into a fixture 200 may have its third surface 140c located upon the first locator surface for dimension three 320. In certain embodiments, and without limitation, the first locator surface for dimension three 320 may be engaged with an actuator 400 adapted to apply a load to third surface 140c and thereby compress fourth surface 140d against the second locator surface for dimension three 340 and thereby hold the section of the beam component 140 coinciding with the first locator surface set for dimension three 310 in a location along dimension three defined by the second locator surface for dimension three 340.

As shown in FIG. 2, in certain embodiments, and without limitation, a beam component introduced into a fixture 200 may have its fourth surface 140d located upon the fourth locator surface for dimension three 342. The beam component introduced into a fixture 200 may have its third surface 140c located upon the third locator surface for dimension three 322. In certain embodiments, and without limitation, the third locator surface for dimension three 322 may be engaged with an actuator 402 adapted to apply a load to third surface 140c and thereby compress fourth surface 140d against the fourth locator surface for dimension three 342 and thereby hold the section of the beam component 140 coinciding with second locator surface set for dimension three 312 in a location along dimension three defined by the fourth locator surface for dimension three 342.

As shown in FIG. 2, in certain embodiments, and without limitation, a beam component introduced into a fixture 200 may have its fourth surface 140d located upon the sixth locator surface for dimension three 344. The beam component introduced into a fixture 200 may have its third surface 140c located upon the fifth locator surface for dimension three 324. In certain embodiments, and without limitation, the fifth locator surface for dimension three 324 may be engaged with an actuator 404 adapted to apply a load to third surface 140c and thereby compress fourth surface 140d against the sixth locator surface for dimension three 344 and thereby hold the section of the beam component 140 coinciding with third locator surface set for dimension three 314 in a location along dimension three defined by the sixth locator surface for dimension three 344.

In conjunction, two or more of the first locator surface set for dimension three 310, the second locator surface set for dimension three 312, and the third locator surface set for dimension three 314, may apply loads to a beam component 140 to orient the beam component in a particular direction in the work plane 202. In certain embodiments, and without limitation, in conjunction, two or more of the first locator surface set for dimension three 310, the second locator surface set for dimension three 312, and the third locator surface set for dimension three 314, may apply loads to a beam component 140 not oriented along dimension one to reorient the beam component 140 into dimension one.

As shown in FIGS. 2-5, in certain embodiments, and without limitation, a beam component introduced into a fixture 200 may have its first surface 120a located upon the second locator surface for dimension two 290. In certain embodiments, and without limitation, the first locator surface for dimension two 270 may be engaged with an actuator 600 and/or 610 adapted to apply a load to second surface 120b and thereby compress first surface 120a against the second locator surface for dimension two 290 and thereby hold the section of the beam component 140 coinciding with the locator surface set for dimension two 260 in a location along dimension two defined by the second locator surface for dimension two 290.

In certain embodiments, and without limitation, a beam component 120 may be introduced into a fixture 200, a beam component 140 may be introduced into a fixture 200, the fixture 200 may hold at least a cross-section of beam component 120 fixed in a desired orientation and position with respect to beam component 140 while at least part of a joining process is performed to at least partially join beam components 120, 140 to form structural beam 100. In certain embodiments, the joining process may comprise a clamping-joining step wherein during each step a first section of each of elongated beam components 120, 140 is clamped by fixture 200 such that the sections are clamped in a desired orientation and position with respect to one another; part of a joining process is performed to at least partially join the beam components 120, 140. In certain embodiments, and without limitation after a clamping-joining step the beam components 120, 140 may undergo an index step during which the beam components 120, 140 are released and indexed through the fixture 200 by moving them along their direction of elongation by some desired displacement. In certain embodiments, one or more clamping-joining steps are alternated with one or more indexing steps until the entire desired length of the beam components has undergone the desired joining process.

While the method and apparatus for manufacturing a beam section has been described above in connection with the certain embodiments, it is to be understood that other embodiments may be used or modifications and additions may be made to the described embodiments for performing the same function of the method and apparatus for manufacturing a beam section without deviating therefrom. Further, the method and apparatus for manufacturing a beam section may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the method and apparatus for manufacturing a beam section. Therefore, the method and apparatus for manufacturing a beam section should not be limited to any single embodiment, but rather construed in breadth and scope in accordance with the recitation of the attached claims.

What is claimed is:

1. A beam component fixturing apparatus, comprising:
a first locator surface set for a first dimension comprising,
a first locator surface for the first dimension,
a second locator surface for the first dimension, and
said first locator surface for the first dimension and said second locator surface for the first dimension adapted to provide a compressive load on a beam component placed therebetween;
a first locator surface set for a second dimension comprising,
a first locator surface for the second dimension,
a second locator surface for the second dimension, and
said first locator surface for the second dimension and said second locator surface for the second dimension adapted to provide a compressive load on a beam component placed therebetween; and
a first locator surface set for a third dimension comprising,
a first locator surface for the third dimension,
a second locator surface for the third dimension, and
said first locator surface for the third dimension and said second locator surface for the third dimension adapted to provide a compressive load on a beam component placed therebetween.

2. The apparatus of claim 1 wherein, said first locator surface for the first dimension or said second locator surface for the first dimension is engaged with an actuator.

3. The apparatus of claim 2 wherein, said first locator surface for the second dimension or said second locator surface for the second dimension is engaged with an actuator.

4. The apparatus of claim 3 wherein, said first locator surface for the third dimension or said second locator surface for the third dimension is engaged with an actuator.

5. The apparatus of claim 4 wherein, said second dimension is perpendicular to said first dimension.

6. The apparatus of claim 5 wherein, said third dimension is perpendicular to said first dimension.

7. The apparatus of claim 6 wherein, said third dimension is parallel to said second dimension.

8. The apparatus of claim 7 further comprising, a second locator surface set for the third dimension comprising,
a third locator surface for the third dimension,
a fourth locator surface for the third dimension,
said third locator surface for the third dimension and said fourth locator surface for the third dimension adapted to provide a compressive load on a beam component placed therebetween, and
either said third locator surface for the third dimension or said fourth locator surface for the third dimension being engaged with an actuator.

9. The apparatus of claim 8 further comprising, a third locator surface set for the third dimension comprising,
a fifth locator surface for the third dimension,
a sixth locator surface for the third dimension,
said fifth locator surface for the third dimension and said sixth locator surface for the third dimension adapted to provide a compressive load on a beam component placed therebetween, and
either said fifth locator surface for the third dimension or said sixth locator surface for the third dimension being engaged with an actuator.

10. A beam component fixturing apparatus, comprising:
a first locator surface set for a first dimension comprising,
a first locator surface for the first dimension engaged with an actuator,
a substantially fixed second locator surface for the first dimension,
said first locator surface for the first dimension and said second locator surface for the first dimension adapted to provide a compressive load on a beam component placed therebetween;
a first locator surface set for a second dimension, wherein said second dimension is perpendicular to said first dimension, comprising,
a first locator surface for the second dimension engaged with an actuator,
a substantially fixed second locator surface for the second dimension, and
said first locator surface for the second dimension and said second locator surface for the second dimension adapted to provide a compressive load on a beam component placed therebetween; and
a first locator surface set for a third dimension, wherein said third dimension is parallel to said second dimension, comprising,
a first locator surface for the third dimension engaged with an actuator,
a substantially fixed second locator surface for the third dimension, and
said first locator surface for the third dimension and said second locator surface for the third dimension adapted to provide a compressive load on a beam component placed therebetween.
a second locator surface set for the third dimension comprising,
a third locator surface for the third dimension engaged with an actuator,
a substantially fixed fourth locator surface for the third dimension,
said third locator surface for the third dimension and said fourth locator surface for the third dimension adapted to provide a compressive load on a beam component placed therebetween, and
a third locator surface set for the third dimension comprising,
a fifth locator surface for the third dimension engaged with an actuator,
a substantially fixed sixth locator surface for the third dimension,
said fifth locator surface for the third dimension and said sixth locator surface for the third dimension adapted to provide a compressive load on a beam component placed therebetween; and
wherein at least one locator surface comprises a rollable surface.

11. A method of fixturing a beam component, comprising:
clamping a first beam component within a first locator surface set for a first dimension, said first locator surface set for a first dimension comprising,
a first locator surface for the first dimension,
a second locator surface for the first dimension;
clamping a second beam component within a first locator surface set for a second dimension, said first locator surface set for a second dimension comprising,
a first locator surface for the second dimension,
a second locator surface for the second dimension; and
clamping the first beam component within a first locator surface set for a third dimension, said first locator surface set for a third dimension comprising,
a first locator surface for the third dimension,
a second locator surface for the third dimension.

12. The apparatus of claim 11 wherein, said second dimension is perpendicular to said first dimension.

13. The apparatus of claim 12 wherein, said third dimension is perpendicular to said first dimension.

14. The apparatus of claim 13 wherein, said third dimension is parallel to said second dimension.

15. The method of claim 14, further comprising, clamping the second beam component within the first locator surface set for a first dimension.

16. The method of claim 15, further comprising, clamping the first beam component within a second locator surface set for the third dimension, said second locator surface set for the third dimension comprising,
a third locator surface for the third dimension, and
a fourth locator surface for the third dimension.

17. The method of claim 16, further comprising, clamping the first beam component within a third locator surface set for the third dimension, said third locator surface set for the third dimension comprising,
a fifth locator surface for the third dimension, and
a sixth locator surface for the third dimension.

18. The method of claim 17 further comprising, clamping the first beam component and the second beam component together.

19. The method of claim 18 wherein said clamping is performed with an actuator comprising hydraulic machinery.

20. The method of claim 19, wherein at least one locator surface comprises a rollable surface.
